(19) United States
(12) Patent Application Publication
(10) Pub. No.: US 2026/0311713 A1
(43) Pub. Date: Oct. 8, 2026

(54) NEURAL AUDIO CODEC TO CODEC TRANSLATION FOR INTEROPERABILITY

(71) Applicant: Cisco Technology, Inc., San Jose, CA (US)

(72) Inventors: Yusuf Ziya Isik, Edinburgh (GB); Taha Mohamed Emara, Edinburgh (GB)

(21) Appl. No.: 19/171,449

(22) Filed: Apr. 7, 2025

(51) Int. Cl. G10L 19/038; G06N 3/0455; G10L 25/30

(52) U.S. Cl. CPC G10L 19/038; G06N 3/0455; G10L 25/30

(57) ABSTRACT

A method for enabling interoperability between an audio neural network-implemented encoder that is incompatible with a neural network-implemented decoder. The method includes receiving an output of a neural network-implemented audio encoder, generating a translated output from the output of a neural network-implemented audio encoder, and delivering the translated output as input to a neural network-implemented audio decoder for audio playback, wherein the output of the neural network-implemented audio encoder is incompatible as input to the neural network-implemented audio decoder for audio playback of audio encoded by the neural network-implemented audio encoder.

### TECHNICAL FIELD

The present disclosure relates to audio processing, and more particularly to audio processing using a neural audio coder-decoder (codec) system that enables interoperability between different codecs, or versions of codecs, and/or that provides improved operational performance of the system.

### BACKGROUND

Audio coding/decoding systems play a role in real-time communication technologies, aiming to preserve audio content quality and intelligibility while minimizing bit consumption. The integration of machine learning techniques and the development of end-to-end neural codecs have driven advancements in bitrate reduction and audio quality.

In addition to encoding the audio signal, there is a role for audio enhancement in extensively utilized real-time communication solutions. Deep neural networks have shown promising results in addressing the challenges of audio enhancement in noisy and reverberant environments.

### BRIEF DESCRIPTION OF THE DRAWINGS

FIG. 1 is a system block diagram of a neural network-implemented audio codec system according to an example embodiment.

FIG. 2 is a diagram depicting end-to-end training of a neural network-implemented audio codec system according to an example embodiment.

FIG. 3 is a block diagram of a system that enables interoperability between a neural network-implemented audio encoder at a transmit side and neural network-implemented audio decoder at a receive side according to an example embodiment.

FIG. 4 is a block diagram of another system that enables interoperability between a neural network-implemented audio encoder at a transmit side and neural network-implemented audio decoder at a receive side according to an example embodiment.

FIG. 5 is a block diagram of yet another system that enables interoperability between a neural network-implemented audio encoder at a transmit side and neural network-implemented audio decoder at a receive side according to an example embodiment.

FIG. 6 is a block diagram of still another system that enables interoperability between a neural network-implemented audio encoder at a transmit side and neural network-implemented audio decoder at a receive side according to an example embodiment.

FIG. 7 shows one codec among several codecs that is selected to operate as an intermediate codec to achieve interoperability between codecs according to an example embodiment.

FIG. 8 is a flowchart depicting a series of operations that may be executed by a neural network-implemented audio codec system according to an example embodiment.

FIG. 9 is a block diagram of a computing device that may be configured to host translation logic for codec interoperability, and to perform techniques described herein, according to an example embodiment.

### DETAILED DESCRIPTION

### Overview

A method for enabling interoperability between a neural network-implemented audio encoder that is incompatible with a neural network-implemented audio decoder. The method includes receiving an output of a neural network-implemented audio encoder, generating a translated output from the output of a neural network-implemented audio encoder, and delivering the translated output as input to a neural network-implemented audio decoder for audio playback, wherein the output of the neural network-implemented audio encoder is incompatible as input to the neural network-implemented audio decoder for audio playback of audio encoded by the neural network-implemented audio encoder.

A device is also described and includes an interface configured to enable network communications, a memory, and one or more processors coupled to the interface and the memory, and configured to: receive an output of a neural network-implemented audio encoder, generate a translated output from the output of a neural network-implemented audio encoder, and deliver the translated output as input to a neural network-implemented audio decoder for audio playback, wherein the output of the neural network-implemented audio encoder is incompatible as input to the neural network-implemented audio decoder for audio playback of audio encoded by the neural network-implemented audio encoder.

### EXAMPLE EMBODIMENTS

### Neural Network Audio Codec System

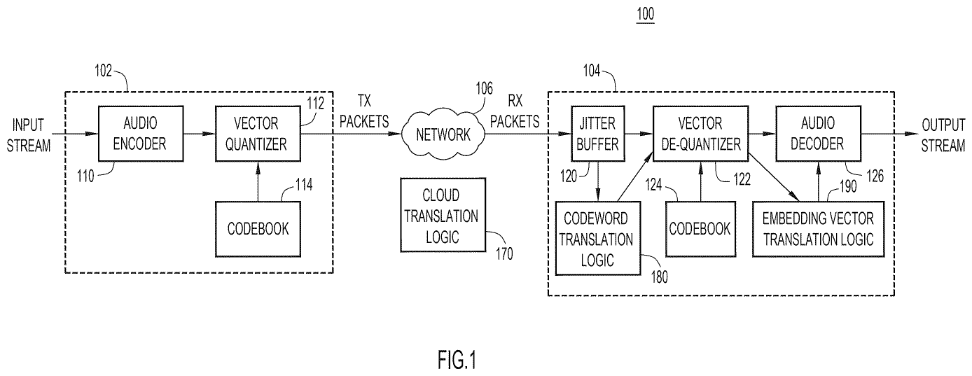

Reference is first made to FIG. 1, which shows a block diagram of a neural audio coder/decoder (codec) system 100. The neural audio codec system 100 includes a transmit side 102 and a receive side 104 (e.g., a remote endpoint) that may be implemented as separate devices that are in communication with each other via network 106. The network 106 may be a combination of (wired or wireless) local area networks, (wired or wireless) wide area networks, public switched telephone network (PSTN), etc.

At the transmit side 102, there is an audio encoder 110 and a vector quantizer 112. The vector quantizer uses a codebook 114. The audio encoder 110 receives an input audio stream (that includes speech as well as artifacts and impairments, such as background noise). The audio encoder 110 may use a deep neural network that takes the input audio stream and transforms it, frame-by-frame, into high-dimensional embedding vectors that keep important/desired information and optionally removes unwanted information such as the artifacts and impairments. The duration of the frames may be 10-20 millisecond (ms), for example. The audio encoder 110 may be composed of convolutional, recurrent, attentional, pooling, or fully connected neural layers as well as any suitable nonlinearities and normalizations. The vector quantizer 112 quantizes the high-dimensional vectors at the output of the audio encoder 110. These vectors are referred to as “embedding vectors” herein. For example, the vector quantizer 112 may use techniques such as Residual Vector Quantization by selecting a set of codewords (from the codebook 114) from each layer to optimize a criterion reducing quantization error at the output stream on receive side 104. The codewords, or indices of the selected codewords, for each frame are put into transmit (TX) packets and sent to the receive side 104, or they may be stored for later retrieval and use. In some implementations, the audio encoder 110 may generate the quantized vectors (indices) directly without the need for a separate vector quantizer 112. Those skilled in the art will appreciate that although a vector quantizer 112 is described, in general any quantizer could be used. For example, the quantizer could be a finite scale quantizer that compresses each dimension of the embedding separately.

As noted, the audio encoder 110 may use a deep neural network that takes the input audio stream and transforms it, frame-by-frame, into high-dimensional embedding vectors that keep all the important information and optionally removes unwanted information such as the artifacts and impairments.

The receive side 104 obtains receive (RX) packets from the network 106. At the receive side 104, there are a jitter buffer 120, a vector dequantizer 122, a codebook 124 and an audio decoder 126. The jitter buffer 120 keeps track of the incoming packets, putting them in order and deciding when to process and play a packet. The jitter buffer 120 may also be used to detect packet loss. The vector dequantizer 122 dequantizes received codeword indices and, using the codebook 124, which matches the codebook 114, outputs recovered embedding vectors. The audio decoder 126 decodes the embedding vectors to produce an output audio stream.

Though not specifically shown in FIG. 1, there may be an encoder, vector quantizer, vector de-quantizer and decoder at each device to enable two-way communications, thus enabling each side to function as a both coder and decoder, i.e., each side is implemented as a full codec.

The system 100 comprising transmit side 102 and receive side 104 has proven to function well and can be trained to, among other things, perform denoising, dereverberation, and packet loss concealment. However, when an arrangement such as neural audio codec system 100 is deployed in a communication system, it is possible that different versions of a given codec are deployed on the transmit side 102 and the receive side 104 due to different computation and budget constraints of the devices at the transmit side 102 and the receive side 104. That is, some devices might support higher complexity codec versions whereas other devices might only be able to support lower complexity codec versions. Moreover, it is tempting to upgrade the system 100 in subsequent generations/versions in an effort to improve quality and/or to add additional features. In machine learning-based systems, however, it can be challenging to assure backward compatibility between different generations/versions of the same system without limiting the capabilities of the later generations/versions. Moreover, not all users joining the same call/meeting will necessarily have access to the same version of the codec, perhaps due to upgrade timing/scheduling.

Given the potential for operation or functionality incompatibility between transmit side 102 and receive side 104, embodiments are provided herein that are configured to address operational discrepancies between the two sides. In this regard, and referring again to FIG. 1, one or more of cloud translation logic 170, codeword translation logic 180, and/or embedding vector translation logic 190 may be deployed in system 100 to enable interoperability between different codec versions, or even between codecs from different suppliers. These different instances of cloud translation logic 170, codeword translation logic 180, and/or embedding vector translation logic 190 may be implemented using artificial intelligence (AI) and machine learning (ML), as will be explained further below. As those skilled in the art will come to appreciate, selected features or functions of each of cloud translation logic 170, codeword translation logic 180, and/or embedding vector translation logic 190 can be executed in different parts of the system.

Preliminarily, techniques are provided for an AI architecture built on the neural audio codec system 100 shown in FIG. 1. At the core of this architecture is a compact speech vector that has great potential for a wide range of speech AI and other applications. The proposed unified architecture offers a versatile solution applicable to various content, including but not limited to: speech enhancement (such as background noise removal, de-reverberation, speech super-resolution, bandwidth extension, gain control, and beamforming), packet loss concealment (with or without forward error correction (FEC)), acoustic/automatic speech recognition (ASR), speech synthesis, also referred to as text-to-speech (TTS), voice cloning and morphing, speech-to-speech translation (S2ST), and audio-driven large language model (AdLLM).

### Training the Neural Network Audio Codec System

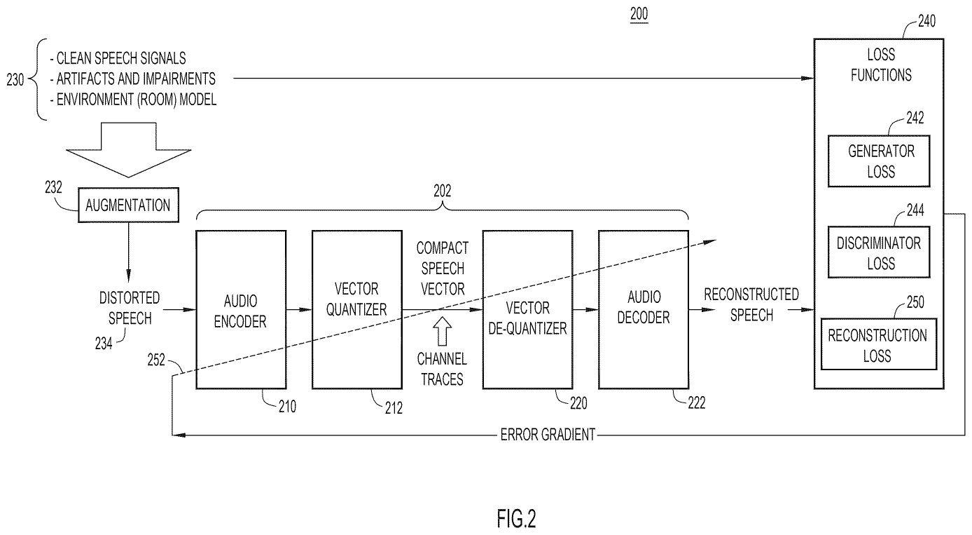

Reference is now made to FIG. 2. FIG. 2 shows an arrangement 200 by which components of a neural audio codec system 202 are trained end-to-end using thousands of hours of speech and artifacts and impairments. Similar to FIG. 1, the neural audio codec system 202 includes an audio encoder 210, vector quantizer 212, vector de-quantizer 220 and audio decoder 222, and each of these components may use a neural network model (or more generally machine learning-based model) for their operations.

To train the neural audio codec system 202, and as shown at reference numeral 230, various artifacts and impairments are applied to the clean speech signals through an augmentation operation 232 to produce distorted speech 234. The artifacts and impairments may include background noise, reverberation, band limitation, packet loss, etc. In addition, an environment model, such as a room model, may be used to impact the clean speech signals. The distorted speech 234 is then input into the neural audio codec system 202.

The training process involves applying loss functions 240 to the reconstructed speech that is output by the audio decoder 222. The loss functions 240 may include reconstruction loss 250 and adversarial losses (e.g., generator loss 242 and discriminator loss 244). The loss functions 240 output an error gradient that is used to adjust parameters of the neural network models used by the audio encoder 210, vector quantizer 212, vector de-quantizer 220 and audio decoder 222, as shown at 252. Thus, the neural network models used by the audio encoder 210, vector quantizer 212, vector de-quantizer 220 and audio decoder 222 may be trained in an end-to-end hybrid manner using a mix of reconstruction and adversarial losses.

As a result of this training, the audio encoder 210 takes raw audio input and leverages a deep neural network to extract a comprehensive set of features that encapsulate intricate speech and background noise characteristics jointly or separately. The extracted speech features represent both the speech semantic as well as speech stationary attributes such as volume, pitch modulation, accent nuances, and more. This represents a departure from conventional audio codecs that rely on manually designed features, whereas in the embodiments presented herein, the neural audio codec system learns and refines its feature extraction process from extensive and diverse datasets, resulting in a more versatile and generalized representation.

The output of the audio encoder 210 materializes as a series of embedding vectors, with each vector encapsulating a snapshot of audio attributes over a timeframe. The vector quantizer 212 further compresses the embedding vector into a compact speech vector, i.e., codewords, using a residual vector quantization (RVQ) model. Vector quantizer 212 may also be implemented using product vector quantization, also known as group vector quantization. Such an approach employs multiple layers, but unlike RVQ, each layer works in parallel. The embodiments described herein are not limited to any particular quantizer implementation. That is, as mentioned, the system may employ finite scale quantization approaches. The codeword indices streams are ready for transmission or storage. At the receiving end, the audio decoder takes the compressed bitstream as input, reverses the quantization process, reconstructs the speech into time-domain waveforms.

The end-to-end training may result in a comprehensive and compact representation of clean speech. This is a data-driven compressed representation of speech, where the representation has a lower dimensionality that makes it easier to manipulate and utilize than if the speech were in its native domain. By “data-driven” it is meant that the representation of speech is developed or derived through ML-based training using real speech data, rather than a human conjuring the attributes for the representation. The data used to train the models may include a wide variety of samples of speech, languages, accents, different speakers, etc.

In the use case of speech enhancement, the compact speech vector represents “everything” to recover speech but discarding, or separating out, anything else related to artifacts or impairments. Thus, for speech enhancement applications, the neural audio codec system does not encode audio, but rather, encodes, individually, speech, music, background noise, etc. In so doing, the neural audio codec system can produce a richer and customizable experience for both the transmit side 102 and the receive side 104.

### Loss Functions Useful During Training

Reconstruction losses may be used to minimize the error between the clean signal, known as a target signal, x and an enhanced signal generated by the neural audio codec, denoted \hat{x}, which is denoised and dereverberated and/or with concealed packets/frames loss of its input signal y, noisy, reverberated audio signal and/or with lost packets/frames. One or more reconstruction losses may be used in the time domain or time-frequency domain.

A loss in the time domain may involve minimizing a distance between estimated clean \hat{x} and the target signal x time domain:

$${ℒ}_{t} = {\sum }_{n = 1}^{N} \vert x [ n ] - \hat{x} [ n ] \vert ,$$

where [symbol] ₜ is the L1 norm loss and N denotes to number of samples of \hat{x} and x in the time domain, where L1 Norm is a sum of the magnitudes of the vectors in a space and is one way to measure distance between vectors (sum of absolute difference of components of the vectors). In some implementations, the L1 norm loss and/or the L2 norm loss may be used.

A weighted signal-to-distortion radio (weighted SDR) may be used, where the input signal y is represented as x with additive noise n: y=x+n, then SDR loss is defined as:

$${ℒ}_{SDR} ( x , \hat{x} ) = - \frac{〈 x , \hat{x} 〉}{‖ x ‖ ‖ \hat{x} ‖} ,$$

where the operator <,> represents the inner product and ∥, ∥ represents Euclidean norm. This loss is phase sensitive with the range [−1,1]. For noise only samples, to be more precise, a noise prediction term is added to define the final weighted SDR loss:

$${ℒ}_{SDR} ( x , n , \hat{n} ) = {ℒ}_{SDR} ( x , \hat{x} ) + {ℒ}_{SDR} ( n , \hat{n} ) ,$$

where \hat{n}=y−\hat{x} is estimated noise.

Multi-scale Short-Time Fourier Transform (MS STFT) operates in the frequency domain using different window lengths. This approach of using various window lengths is inspired by the Heisenberg Uncertainty Principle, which shows that a larger window length gives greater frequency resolution but lower time resolution, and the opposite for a shorter window length. Therefore, the MS STFT uses a range of window lengths to capture different features of the audio waveform.

The loss is defined as:

$${ℒ}_{MSTFT} = {\sum }_{l = 1}^{L} {\sum }_{k = 1}^{K} \vert {S}^{w} [ l , k ] - {\hat{S}}^{w} [ l , k ] \vert + {α}_{w} {\sum }_{l = 1}^{L} {\sum }_{k = 1}^{K} \sqrt{{\vert log ( {S}^{w} [ l , k ] ) - log ( {\hat{S}}^{w} [ l , k ] ) \vert}^{2}} ,$$

where S^{w}[l, k] is the energy of the spectrogram at frame l and frequency bin k and characterized by a window w, K is the number of frequency bins, L is the number of frames and α_{w} is a parameter to balance between L1 Norm and L2 Norm part of the loss, where the L2 Norm is the square root of the sum of the entries of a vector. The second part of the loss is computed using a log operator to compress the values. Generally, most of the energy content of speech signal is concentrated below 4 kHz. Therefore, the energy magnitude in lower frequency components is significantly higher than higher frequency components, with going to log domain, the magnitude of higher frequencies and lower frequencies get closer, thus more focus on higher frequency components compared to linear scale. A high-pass filter can be designed to improve performance for high-frequency content.

A Mean Power Spectrum (MPS) loss function aims to minimize the discrepancy between the mean power spectra of enhanced and clean audio signals in the logarithmic domain using L2 Norm.

The power spectrum of the signal is computed as below:

$$P ( x ) = \frac{1}{N} {\sum }_{n = 0}^{N - 1} {\vert {X}_{n} \vert}^{2} ,$$

where P(x) is the mean power spectrum of signal x, X is FFT/STFT of signal x.

A logarithm may be applied to the mean power spectrum (MPS), such that the logarithmic power spectrum of a signal x is:

$$L ( x ) = 10 {log}_{10} ( P ( x ) + ϵ ) ,$$

where ϵ is a small constant to prevent the logarithm of zero.

The MPS loss between the enhanced and clean signals can then be defined as the L2 Norm of the difference between their logarithmic power spectra:

$${ℒ}_{MPS} ( \hat{x} , x ) = \sqrt{\sum {( L ( \hat{x} ) - L ( x ) )}^{2}} .$$

Generative Adversarial Networks (GANs) comprise two main models: generator and discriminator. In the neural network codec system, the audio encoder, vector quantizer and audio decoder may employ GAN generator and discriminator models. As an example, two adversarial loss functions could be used in the neural audio codec system: Lease-squared adversarial loss functions and hinge loss functions.

Least square (LS) loss functions for discriminator and generator may be respectively defined as:

$${ℒ}_{ADV} ( D ; G ) = {E}_{( x , s )} [ {( D ( x ) - 1 )}^{2} + {D ( G ( y ) )}^{2} ] ,$$

$${ℒ}_{ADV} ( G ; D ) = {E}_{d} [ {D ( G ( y ) - 1 )}^{2} ] ,$$

For discriminator loss, [symbol] _{ADV}(D; G), E_{(,)} is the expectation operator, D(x), is the output of the discriminator for a real signal x, D(G(y)) is the discriminator output of enhanced (fake) signal and [symbol] _{ADV}(G; D) is the generator loss.

Hinge loss for the discriminator and generator may be defined as:

$${ℒ}_{ADV} ( D ; G ) = {E}_{( x , y )} [ max ( 1 - D ( x ) , 0 ) + max ( 0 , 1 + D ( G ( y ) ) ) ] , \\ {ℒ}_{ADV} ( G ; D ) = {E}_{y} [ max ( 1 - D ( G ( y ) ) , 0 ) ] ,$$

Hinge loss may be preferred over least square loss because in the case of discriminator loss, hinge loss tries to maximize the distance between the real signal and fake signal while LS loss tries to score 1 when the input is a “real signal” and 0 when the input is “fake signal”.

In addition to above-mentioned losses, feature matching may be used to minimize the difference between the intermediate features of each layer of real and generated signals when passed through the discriminator. Instead of solely relying on the final output of the discriminator, feature matching ensures that the generated samples have similar feature statistics to real samples at various levels of abstraction. This helps in stabilizing the training process of adversarial networks by providing smoother gradients. Feature matching loss may be defined as:

$${ℒ}_{F M} ( G ; D ) = {E}_{( x , y )} [ {\sum }_{i = 1}^{T} \frac{1}{{N}_{i}} {‖ {D}^{i} ( x ) - {D}^{i} ( G ( y ) ) ‖}_{1} ] ,$$

where Nᵢ is the number of layers in the discriminator D, and superscript i is used to design the layer number. Note that feature matching loss updates only generator parameters.

Several different discriminator models may be suitable for use in the training arrangement of FIG. 2, including: Multi-Scale Discriminator (MSD), Multi-Period Discriminator (MPD) and Multi-Scale Short-Time Fourier Transform (MS-STFT).

For a MSD, the discriminator is looking at the waveform at the different sampling rates. The waveform discriminators have the same network architecture but use different weights. Each network is composed of n number of strided 1-dimensional (1D) convolution blocks, an additional 1D convolution, and global average pooling to output a real-value score. A “leaky” rectifier linear unit (Leaky ReLu) may be used between the layers for the purpose of non-linearity of the network.

A MPD operates on the time-domain waveform and tries to capture implicit periodicity structure of the waveform. In an MPD discriminator, different periods of the waveform are considered. For each period, the same network architecture, with different weights, are used. The network consists of n strided two-dimensional (2D) convolution blocks, an additional convolution, and a global average pooling for outputting a scalar score. In the convolution block weight normalization may be used along with a Leaky ReLu as an activation function.

An MS-STFT discriminator, unlike the MSD and MPD, operates in the frequency domain using a Short-Time Fourier Transform (STFT). This discriminator enables the model to analyse the spectral content of the signal. The MS-STFT discriminator analyses the “realness” of the signal at multiple time-frequency scales or resolutions. Having spectral content of the waveform in various resolutions, the model is able to analyze the “realness” of the waveform more profoundly. The MS-STFT discriminator may be composed of t equivalent networks that handle multi-scaled complex-valued STFTs with incremental window lengths and corresponding hop sizes. Each of these networks contains a 2D convolutional layer, with weight normalization applied, featuring a n×m kernel size and c number of channels, followed by a Leaky ReLu non-linear activation function. Subsequent 2D convolution layers have dilation rates in the temporal dimension and an output stride of j across the frequency axis. At the end we have d×d convolution with stride 1 followed by flatten layer to get the output scores.

Finally, the total loss of adversarial training may be defined as:

$$ℒ = {λ}_{F M} {ℒ}_{F M} + {λ}_{MSTFT} {ℒ}_{MSTFT} + {λ}_{G} {ℒ}_{ADV} ( G ; D ) + {λ}_{D} {ℒ}_{ADV} ( D ; G ) + {λ}_{t} {ℒ}_{t} + {λ}_{SDR} {ℒ}_{SDR} + {λ}_{MPS} {ℒ}_{MPS} ,$$

where λ coefficients are used to give more weights to some losses compared to the other losses, [symbol] _{FM} is the feature matching loss. [symbol] _{MSTFT} is MS-STFT loss that can be replaced by [symbol] _{MSD} for MSD discriminator or [symbol] _{MPD} for MPD discriminator.

Any one or more of the loss functions referred to above, or other loss functions now known or hereinafter developed, may be used in the training process depicted in FIG. 2. The architecture of the end-to-end training, from the encoder side to the decoder side, produces the embedding vectors that can be exploited for a variety of applications as described below. The training results in an embedding vector representation that lends itself to convergence, accuracy, etc. Again, this is a result of the characteristics that are trained for, selection of loss functions, training content, selection criteria for epics, etc., to arrive at the embedding vectors that have desirable characteristics of: rejecting non-speech (for speech enhancement applications), easy to encode speech, and durability across speech applications.

### Codec-to-Codec (or Encoder-to-Decoder) Interoperability

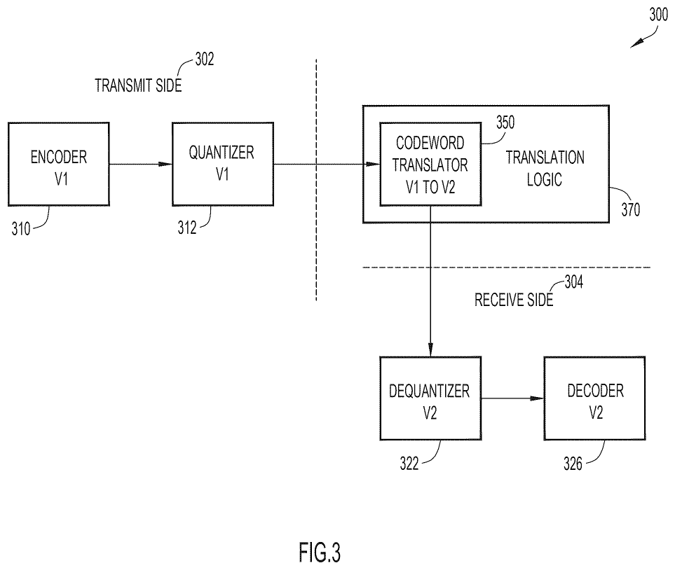

As noted previously, it is possible that the encoder and decoder (or paired codecs) are incompatible with one another due to hardware constraints, deployment scheduling, etc. In this regard, FIG. 3 is a block diagram of a system 300 that enables interoperability between a neural network-implemented audio encoder at a transmit side and neural network-implemented audio decoder at a receive side, wherein an output of the neural network-implemented audio encoder is incompatible as input to the neural network-implemented audio decoder for audio playback, according to an example embodiment. The following discussion presumes that the neural network-implemented audio encoder is based on a different version compared to the neural network-implemented audio decoder (i.e., version v1 versus version v2). However, those skilled in the art will appreciate that the embodiments described herein will also address interoperability issues between an encoder and decoder (or codecs) from different manufacturers or suppliers.

FIG. 3 shows a system 300, similar to FIG. 1, having a transmit side 302 including an encoder v1 310 and a quantizer v1 312 (which may also collectively be referred to, broadly, as an “encoder” or “audio encoder” or “neural network-implemented audio encoder”). A receive side 304 includes a dequantizer v2 322 and a decoder v2 326 (which may also collectively be referred to, broadly, as a “decoder”). As depicted, the encoder and decoder are effectively incompatible (v1 versus v2) in that the output of the quantizer v1 312 (namely, a series of codewords, or indexes thereof) is incompatible as input to the dequantizer v2 322. More specifically, the codewords (or indexes thereof) supplied to receive side 304 cannot be dequantized to embedding vectors consistent with embedding vectors generated by encoder v1 310, and thus audio generated by decoder v2 326 will not mirror or re-generate audio that was input to encoder v1 310. To address this issue, translation logic 370, which can be deployed in the cloud between transmit side 302 and receive side 304, is provided and includes a v1 to v2 codeword translator 350 (or index translator). Although possibly being deployed or disposed in the cloud between devices that host transmit side 302 and receive side 304, v1 to v2 codeword translator 350 (and other translation logic described herein) could likewise be deployed at receive side 304.

In operation, and as previously explained in connection with FIG. 1, quantizer v1 312 in FIG. 3 generates one or more codeword indices per output of encoder v1 310. Assume that encoder v1 310 generates an embedding vector for every 10 ms of audio. Assume that quantizer v1 312 has a fixed codebook of size V. Thus, for every embedding vector, quantizer v1 310 finds the closest codeword in a codebook (not shown in FIG. 3) and sends the index of the codeword (a number from 1 to V), to receive side 304. In this regard, encoder v1 310 together with quantizer v1 312 can be seen as converting the audio sequence at a given sampling rate to a sequence of codeword indexes. The sequence of codeword indexes can be considered “words” coming from a vocabulary of size V, and the indexes are the words in the vocabulary. As those skilled in the art will appreciate, each codec system has its own codebook (vocabulary) and converts the audio into text (codeword indexes) using its own vocabulary and language.

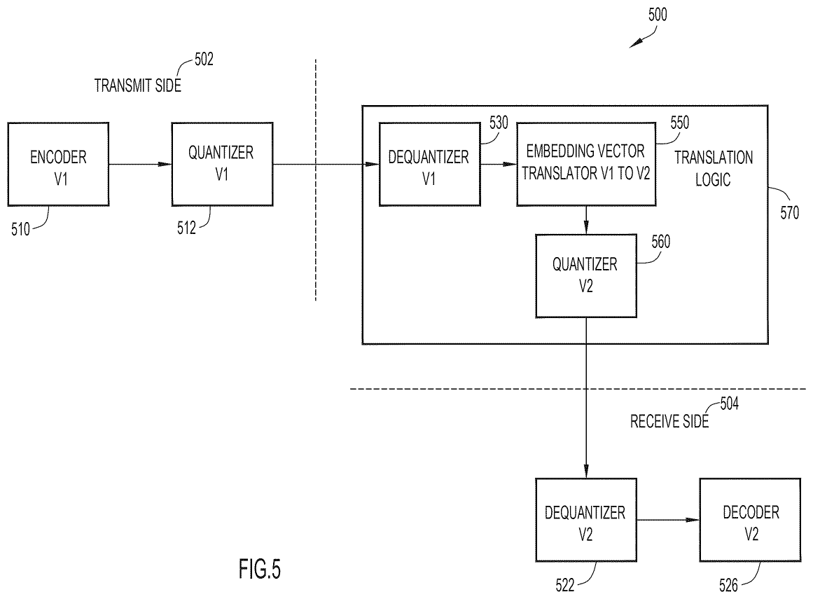

To enable interoperability between incompatible codec systems (or encoders and decoders), and as shown in FIG. 3, translation logic 370 intercepts the sequence of codeword indexes from transmit side 302 and translates it into a sequence of codeword indexes that is compatible with dequantizer v2 322 and decoder v2 326 such that if the original audio had been input to an encoder+quantizer trained with dequantizer v2 322 and decoder v2 326 that same (or very similar) translated sequence would have been generated. Notably, translation logic 370 is not a simple lookup table matching a given index from quantizer v1 312 to a given index compatible with dequantizer v2 322. Rather, translation logic 370, including v1 to v2 codeword translator 350, comprises a trained neural network that operates in a streaming fashion to generate matching pairs of codeword index sequences for the same audio input using the two different (or versions of) codecs. In this regard, translation logic 370 may be implemented as a “translator network” and may operate using a machine learning based sequence-to-sequence architecture. For example, translation logic 370 could be implemented as a transformer network utilizing multi-head attention blocks, a convolutional neural network, and/or a recurrent neural network. For example, assume a system having Encoder v2 (not shown) and Quantizer v2 560 (shown in FIG. 5) that are compatible with dequantizer v2 322 and decoder v2 326 and, together, constitute a full codec. To be able to train the “translator network,” the system feeds a large-scale training dataset of speech utterances to both Encoder v1 310 followed by quantizer v1 312, and Encoder v2 followed by quantizer v2 560 generating two codeword index sequences per utterance in the training dataset. By this procedure, the system generates paired codeword sequences representing the same utterance for codec system v1 and codec system v2. This is similar to having a training set of paired sentences in two languages, say English and French, for training a machine translation system. Note that due to the nature of the task, generating paired sequences of codeword indexes for two codec systems is relatively straight forward by using very large and diverse datasets. For each pair in the training set, the translator network takes the codeword sequence corresponding to codec system v1, and tries to generate the codeword sequence of codec system v2 as close as possible. The translator network's output layer has V output nodes, where V is the vocabulary size for the codec system v2. The translator network generates a probability of each codeword index for every output frame. The translator network is trained to give high probability to the correct codeword index, and low probability to all the others. Loss functions such as Cross Entropy Loss or connectionist temporal classification loss (CTC) may be used in updating the translator network parameters so that they generate the correct output sequence as close as possible. Note that similar to machine translation of human languages, it is not required that the two codeword sequences be of the same length. For example, Encoder v1 310 might be generating frames every 20 ms (50 frames per second) whereas Encoder v2 might be generating frames every 10 ms (100 frames per second). In such cases, an intermediate layer of the translator network could apply appropriate up-sampling or down-sampling operations to have the correct length at the output. The translator network could use layers typically applied in sequence-to-sequence mapping networks, such as cross and self-attention transformer layers, recurrent layers, convolution layers, nonlinear activations, normalization layers etc. The translator network could also be designed to be auto-regressive. That is in addition to taking the codec system v1's codeword sequence as input, it also takes the codeword index it generates as output for the previous time steps as input. That is, the system feeds its output back to its input for it to also condition on its previous outputs within the same utterances and earlier time steps.

Another approach to use in training the translator network is to sample codeword indices at the output of the translator network and feed it to dequantizer v2 322 and decoder v2 326. The system then compares generated audio to the reference audio with the loss functions detailed in connection with FIG. 2 and backpropagates the error gradient back to the translator network. Note that dequantizer v2 322 and decoder v2 326 are pre-trained and not updated in this setting. In this approach, the system does not need to generate the paired training dataset. Instead, the system generates the codeword sequence for Encoder v1 310 and quantizer v1 312 to give as input to the translator network. Similar to the first approach, the translator network generates probabilities over the vocabulary of codec system v2 for each output time step. The system samples codeword indexes from this probability distribution and sends the generated codeword sequence to dequantizer v2 322 and decoder v2 326 to get the reference audio back. To reduce error, the translator network should generate similar codeword sequence to codec system v2. This approach takes decoder v2 326 also into account and can reduce the translation errors that leads to degraded audio quality at the decoder output but otherwise ignores translation errors that decoder v2 326 is not affected from.

The translation of the codeword indexes output from one codec to another codec could also be used to boost the performance of a lower complexity, lower quality, codec, or one with less features/capabilities to have similar quality/features of a higher complexity or quality codec. As an example, assume that the transmit side 302 is a relatively low complexity version of a neural network-implemented codec that encodes audio without denoising, while there exists a relatively higher complexity neural network-implemented codec that can apply denoising on transmit side 302. When translation logic 370 converts the codeword indexes of the lower complexity encoder to the higher complexity version either in the cloud or on the receive side 304, the system will not only be able to use the high complexity decoder on the receive side 304, but will also benefit from the denoising.

More specifically, the resulting denoising is actually a benefit of translator network training. Assume that codec system v2 has a denoising encoder, but that an encoder of codec system v1 is not applying denoising and has less complexity. For the same noisy input utterance, codec system v2 generates a codeword sequence that is similar to the codeword sequence of clean reference audio (a denoised version of the noisy input), whereas codec system v1 generates a codeword sequence that contains both speech and noise information. When the system generates the paired training set, codec system v2's codeword sequence will be similar to codewords of a clean reference due to denoising, whereas codec system v1's codeword sequence will be similar to codewords of the noisy input. The translation not only converts between the vocabulary of two codecs, but it implicitly also applies denoising in the codeword indices space.

As another example of incompatibility, consider a scenario in which transmit side 302 is operating with a hop size of 10 ms (100 embeddings per second) and the receive side 304 is configured to operate at a hop size of 20 ms (50 embeddings per second), In this case, translation logic 370 is trained to to align and convert between sequences of different lengths while translating to map the two sequences.

Another possible scenario is that one codec may not have a codeword allocated for a particular acoustic event while the other codec has such a codeword. As an example, consider codec v1 has not been trained with any Chinese data and has some challenges with certain Chinese phonemes, leading to, potentially, lower low quality speech regeneration. On the other hand, codec v2 does not have this same challenge. Translation logic 370 may still learn to map these to correct codeword indices when trained with aligned Chinese sequences, although the quality of the regenerate audio might be lower than codec v2 were used exclusively.

Notably, translation logic 370 can be beneficial for both compute savings and latency. By avoiding dequantization during translation (compared to approaches discussed below), less compute power is needed. Avoiding that step also reduces latency.

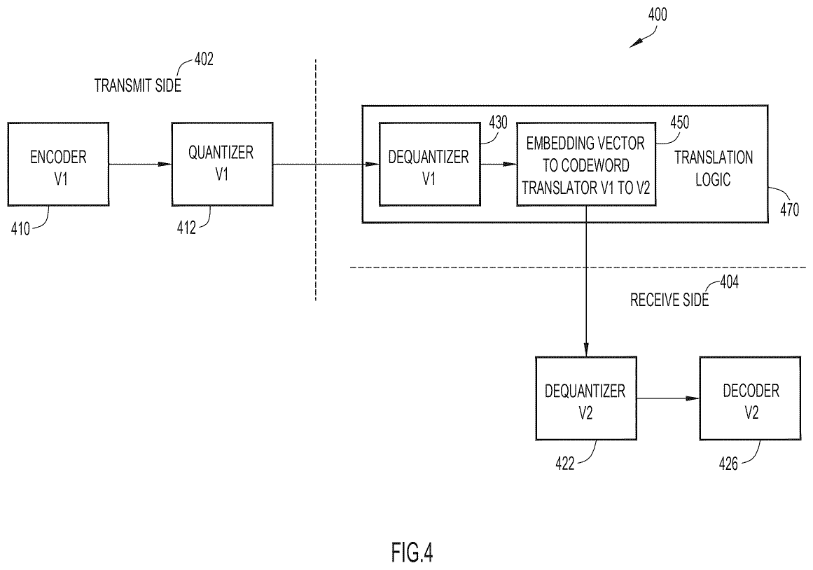

FIG. 4 is a block diagram of another system 400 that enables interoperability between a neural network-implemented audio encoder at a transmit side and neural network-implemented audio decoder at a receive side, wherein an output of the neural network-implemented audio encoder is incompatible as input to the neural network-implemented audio decoder for audio playback, according to an example embodiment. FIG. 4 is similar to FIG. 3 in that it includes a transmit side 402 including an encoder v1 410 and a quantizer v1 412. A receive side 404 includes a dequantizer v2 422 and a decoder v2 426. That is, the encoder and decoder are effectively incompatible (version v1 versus version v2) in that the output of the quantizer v1 412 (namely, a series of codewords, or indexes thereof) is incompatible as input to the dequantizer v2 422. More specifically, the codewords (or indexes thereof) supplied to receive side 404 cannot be dequantized to embedding vectors consistent with embedding vectors generated by encoder v1 410, and thus audio generated by decoder v2 426 will not mirror or re-generate audio that was input to encoder v1 410. To address this issue, translation logic 470 is provided and includes a dequantizer v1 430 and v1 to v2 embedding vector to codeword translator 450, either or both of which could be deployed in the cloud or at receive side 404.

Note that sequence-to-sequence networks, which may be used for translation logic 470, may take discrete tokens as the input and first convert them into word embeddings, which are high dimensional vectors, to work in a continuous domain. This is typically achieved by an embedding layer that works as a look-up table. If such a look-up table step is used in the translator network of translation logic 470, the translator network may optionally use the codebook of the quantizer v1 as the embedding layer. In this regard, dequantizer 430 is deployed between quantizer v1 414 and v1 to v2 embedding vector to codeword translator 450 to apply a dequantization step consistent with quantizer v1 412 to generate the embeddings of encoder v1 410 and then supply those embeddings as input to the v1 to v2 embedding vector to codeword translator 450. The v1 to v2 embedding vector to codeword translator 450 generates the codeword indices suitable for dequantizer v2 422. Thus, instead of translating codewords or indexes as in FIG. 3, translation logic 470 translates embedding vectors to codewords (or indexes) that are compatible with receive side 404.

In this case, there is no need for any special training. As mentioned above, many sequence-to-sequence networks first convert the discrete input token sequence into continuous vectors through a lookup table. The dequantizer v1 430 could be considered as a look-up table similarly, and removes the need to train a separate look-up table.

FIG. 5 is a block diagram of yet another system 500 that enables interoperability between a neural network-implemented audio encoder at a transmit side and neural network-implemented audio decoder at a receive side, wherein an output of the neural network-implemented audio encoder is incompatible as input to the neural network-implemented audio decoder for audio playback, according to an example embodiment. FIG. 5 is similar to FIG. 4 in that it includes a transmit side 502 including an encoder v1 510 and a quantizer v1 512. A receive side 504 includes a dequantizer v2 522 and a decoder v2 526. That is, the encoder and decoder are effectively incompatible (version v1 versus version v2) in that the output of the quantizer v1 512 (namely, a series of codewords, or indexes thereof) is incompatible as input to the dequantizer v2 522. More specifically, the codewords (or indexes thereof) supplied to receive side 504 cannot be dequantized to embedding vectors consistent with embedding vectors generated by encoder v1 510, and thus audio generated by decoder v2 526 will not mirror or re-generate audio that was input to encoder v1 510. To address this issue, translation logic 570 is provided and includes a dequantizer v1 530, a v1 to v2 embedding translator 550, and quantizer v2 560, anyone of which could be deployed in the cloud or at receive side 504.

In the configuration shown in FIG. 5, translation logic 570 includes v1 to v2 embedding vector translator 550 that translates between embedding spaces of the two codecs. If such a translator network operates in the cloud (as shown), dequantizer v1 530 first dequantizes the codewords of quantizer v1 512 back into embedding vectors generated by encoder v1 510, then converts those embedding vectors to embedding vectors consistent with decoder v2 526, and finally quantizes them using quantizer v2 560 into codeword indexes operable with dequantizer v2 522.

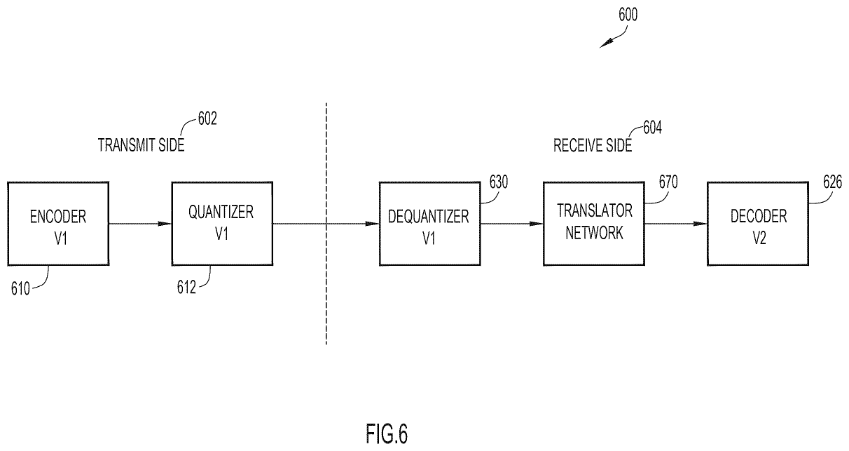

FIG. 6 shows yet another variant of a system 600 that enables interoperability between a neural network-implemented audio encoder at a transmit side 602 and neural network-implemented audio decoder at a receive side 604. The system 600 includes an encoder v1 610, a quantizer v1 612 a dequantizer v1 630, a translator network 670, and a decoder v2 626. As in the approaches depicted in FIGS. 3-5, in the system 600 the encoder and decoder are effectively incompatible (version v1 versus version v2) in that the output of the quantizer v1 612 (namely, a series of codewords, or indexes thereof) is incompatible as input to a dequantizer (not shown) associated with decoder v2 626. More specifically, the codewords (or indexes thereof) supplied to receive side 604 cannot be dequantized to embedding vectors consistent with embedding vectors generated by encoder v1 610, and thus audio generated by decoder v2 626 will not mirror or regenerate audio that was input to encoder v1 610.

To address this incompatibility, translator network 670 receives embedding vectors generated by dequantizer v1 630, and translates them to embedding vectors that are compatible with decoder v2 626. In this approach, on the receive side 604, no formal dequantization according to version 2 is needed as the translator network 670 is trained to perform the desired translation.

Note that the two training approaches, either with paired sequences or end-to-end training as explained above, could also be adapted for this operating mode.

For the paired sequence training, every utterance in the training set is first passed through encoder v1 610, quantizer v1 516, and dequantizer v1 630 to obtain the dequantized embedding vectors corresponding to codec v1. These sequence of dequantized embedding vectors for the input utterance will constitute the input sequence of the translator network 670. The system also feeds the same utterance to an encoder v2 (not shown), quantizer v2 and dequantizer v2 to obtain the dequantized embedding vectors corresponding to codec system v2. These second sequence of vectors for the same utterance will constitute the output sequence of translator network 670 that the system tries to generate as close as possible. The system uses loss functions such as mean square error loss, L1 distance loss, cosine distance loss etc. to compare the output sequence of the translator network 670 and the dequantized embedding sequence of codec system v2 to compute the error and backpropagate it to update parameters of the translator network 670 so that the error is minimized.

Alternatively, the system can only generate the input dequantized embedding sequence for codec system v1, feed it to the translator network 670, and feed the generated output vector sequence directly to the decoder v2 626. The system computes end-to-end losses between the generated audio at the output of decoder v2 626 when codec system v2 dequantized embeddings are presented as input and the generated audio at the output of decoder v2 626 when translator network generated embeddings are presented as input to decoder v2 626. The system can use any subset of the loss functions suitable for comparing two audio sequences some of which are described above.

When translator network 670 operates between the two embedding spaces as shown, alternative sequence-to-sequence conversion models that may be employed include U-net based convolutional networks and diffusion models. Translator network 670 could also be trained with Langevin dynamics with a score generating network.

As bit rate increases in the case where a neural audio codec system employes a single vector quantization (VQ) layer, exponentially more codewords are needed making the approach challenging to implement in high bit rate scenarios. As a remedy, many neural audio codecs use VQ variants that have multiple VQ blocks either running in parallel or serially. As an example, product quantization also known as group quantization, splits the input embedding into as many groups as needed, and separately quantizes each group with a different VQ in parallel, and then concatenates the quantized embeddings back before feeding to the decoder. On the other hand, a common multi-stage VQ that works in serial mode is the residual VQ in which each VQ in the hierarchy works on the residual signal subtracting the VQ output from the input.

For translation logic 470, 570 that translate in the embedding domain, as in FIGS. 5 and 6, having multiple VQ blocks is not an issue as it does not matter whether the quantized embeddings are computed in a single step or multiple steps.

When the translator network receives discrete tokens as input in a multiple VQ system, the tokens are typically converted to word embeddings, as discussed above. As noted, this can be accomplished either using the VQ codebooks as in the dequantization process, or with separate lookup-table based embedding layers. In the second scenario, the same process in the multiple VQ system could be applied for the word embeddings. That is, in case of group quantization, the word embeddings corresponding to different VQ blocks can be concatenated, and in Residual VQ, the different VQ blocks can be summed and provided as input to the translator network. Accordingly, having multiple VQ blocks at the input side of the translator (Codec version 1) could be handled by either of the two ways described.

However, assume now that there are multiple VQ blocks in the codec on the receive side (version 2) that the system translates into, and the v1 to v2 codeword translator 350 is predicting the codeword indexes as in FIG. 3.

If the multiple VQ system is running in parallel as in group or product quantization, v1 to v2 codeword translator 350 may be configured to have either a separate translator network trained for each VQ, or v1 to v2 codeword translator 350 may use the same translator network taking the index of the VQ block and conditioning all the processing to it. This does not pose a significant change as each VQ is working in parallel independently from the others and the translation could be carried out independently. However, where dequantizer v2 322 uses a serial VQ variant such as residual VQ where VQ layers upper in the hierarchy depend on the codewords selected in lower layers, v1 to v2 codeword translator 350 is also configured, for better accuracy, to translate them depending on the predictions for lower layers. In such cases, the translator network of v1 to v2 codeword translator 350 can run as many times as there are VQ layers conditioning on the current VQ layer index as well as the predictions of the v1 to v2 codeword translator 350 for previous layers.

In another variant of the system where a codec v2 has multiple VQ blocks, instead of predicting the selected codeword index of each layer running translator multiple times, the system directly predicts the bit sequence where there are as many output nodes as there are bits per frame. For example, if the system is operating at 6 kbps and if there are 100 frames per second, then each frame will have 60 bits. There might be a 6-layer Residual VQ where each layer has 1024 codewords leading to 10 bits. In one approach the translator network has 1024 output nodes and predicts which codeword is selected. The system can either run a different translator network per layer or run the same network multiple times conditioning on previous inputs and the VQ layer index. In another approach, the translator network might have 60 output nodes corresponding to each of the 60 bits. The output nodes could have sigmoid nonlinearities and approximate 0s or 1s of the 60 bit codeword index.

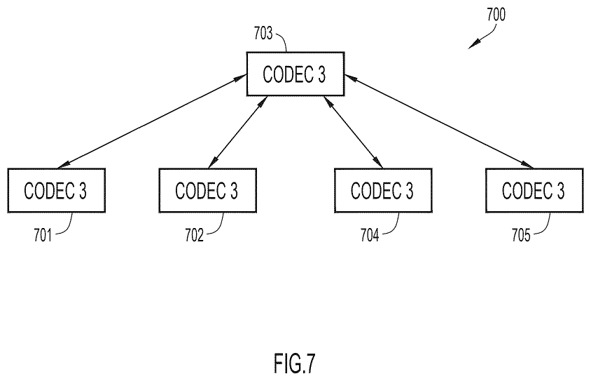

If in a given deployment there are N codecs to interoperate, the number of codec pairs to train the translation logic system is N². This could be prohibitive for a large N. In such a case, and as shown in FIG. 7, a system 700 can be arranged such that one of the codecs, e.g., codec 3 703 (from among codec 1 701, codec 2 702, codec 3 703, codec 4 704, and codec 5 705) is selected as an intermediate representation to translate every codec into, and then translate from this intermediate codec to the target codec. So, for example, the system 700 can be configured to translate from codec 1 701 to codec 2 702 by first translating from codec 1 701 to codec 3 703, and then translating from codec 3 703 to codec 2 702. This will reduce the number of translation pairs to 2^{(N-1)} significantly reducing the training and maintenance overhead of the overall system 700. The codec to use as intermediate representation might be selected based on several criteria. For example, one might choose the codec with highest complexity or the one with most features, or select it empirically based on translation performance.

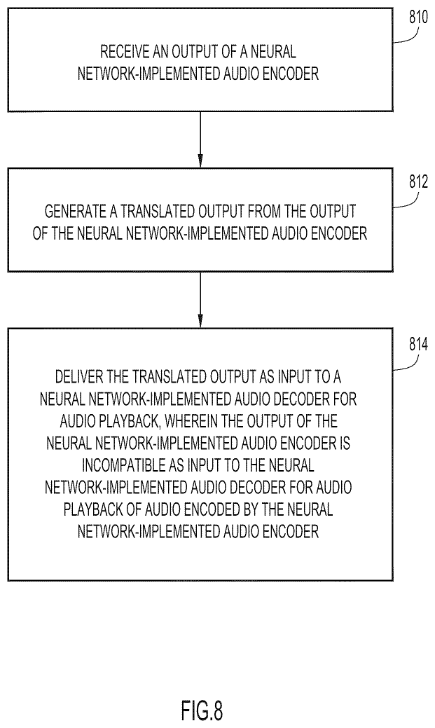

FIG. 8 is a flowchart depicting a series of operations that may be executed by a neural audio codec system according to an example embodiment. At 810, an operation includes receiving an output of a neural network-implemented audio encoder. At 812, an operation includes generating a translated output from the output of a neural network-implemented audio encoder. At 814 an operation includes delivering the translated output as input to a neural network-implemented audio decoder for audio playback. In the context of these operations, the output of the neural network-implemented audio encoder is incompatible as input to the neural network-implemented audio decoder for audio playback of audio encoded by the neural network-implemented audio encoder.

It is noted that the terms “translate” or “translating” as used throughout this description are analogous to terms such “convert”, “converting”, “transform”, “transforming”, “modify” or modifying”, or the like.

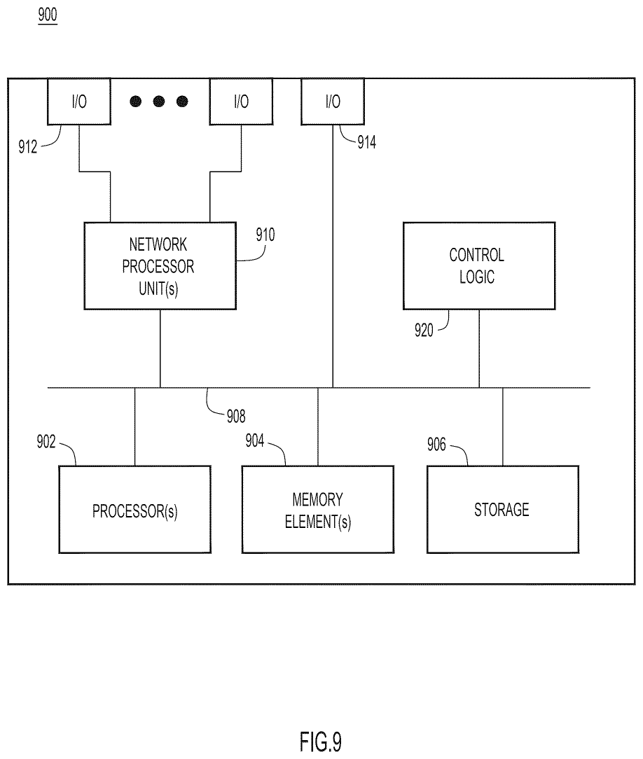

FIG. 9 is a block diagram of a computing device that may be configured to host translation logic 370, 470, 570 or translator network 670, and to perform techniques described herein, according to an example embodiment. In various embodiments, a computing device, such as computing device 900 or any combination of computing devices 900, may be configured as any entity/entities as discussed for the techniques depicted in connection with FIGS. 1-8 in order to perform operations of the various techniques discussed herein.

In at least one embodiment, the computing device 900 may include one or more processor(s) 902, one or more memory element(s) 904, storage 906, a bus 908, one or more network processor unit(s) 910 interconnected with one or more network input/output (I/O) interface(s) 912, one or more I/O interface(s) 914, and control logic 920. In various embodiments, instructions associated with logic for computing device 900 can overlap in any manner and are not limited to the specific allocation of instructions and/or operations described herein.

In at least one embodiment, processor(s) 902 is/are at least one hardware processor configured to execute various tasks, operations and/or functions for computing device 900 as described herein according to software and/or instructions configured for computing device 900. Processor(s) 902 (e.g., a hardware processor) can execute any type of instructions associated with data to achieve the operations detailed herein. In one example, processor(s) 902 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 904 and/or storage 906 is/are configured to store data, information, software, and/or instructions associated with computing device 900, and/or logic configured for memory element(s) 904 and/or storage 906. For example, any logic described herein (e.g., control logic 920) can, in various embodiments, be stored for computing device 900 using any combination of memory element(s) 904 and/or storage 906. Note that in some embodiments, storage 906 can be consolidated with memory element(s) 904 (or vice versa) or can overlap/exist in any other suitable manner.

In at least one embodiment, bus 908 can be configured as an interface that enables one or more elements of computing device 900 to communicate in order to exchange information and/or data. Bus 908 can be implemented with any architecture designed for passing control, data and/or information between processors, memory elements/storage, peripheral devices, and/or any other hardware and/or software components that may be configured for computing device 900. In at least one embodiment, bus 908 may be implemented as a fast kernel-hosted interconnect, potentially using shared memory between processes (e.g., logic), which can enable efficient communication paths between the processes.

In various embodiments, network processor unit(s) 910 may enable communication between computing device 900 and other systems, entities, etc., via network I/O interface(s) 912 (wired and/or wireless) to facilitate operations discussed for various embodiments described herein. In various embodiments, network processor unit(s) 910 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 900 and other systems, entities, etc. to facilitate operations for various embodiments described herein. In various embodiments, network I/O interface(s) 912 can be configured as one or more Ethernet port(s), Fibre Channel ports, any other I/O port(s), and/or antenna(s)/antenna array(s) now known or hereafter developed. Thus, the network processor unit(s) 910 and/or network I/O interface(s) 912 may include suitable interfaces for receiving, transmitting, and/or otherwise communicating data and/or information in a network environment.

I/O interface(s) 914 allow for input and output of data and/or information with other entities that may be connected to computing device 900. For example, I/O interface(s) 914 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 920 can include instructions that, when executed, cause processor(s) 902 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 920) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 904 and/or storage 906 can store data, software, code, instructions (e.g., processor instructions), logic, parameters, combinations thereof, and/or the like used for operations described herein. This includes memory element(s) 904 and/or storage 906 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In sum, a method may include receiving an output of a neural network-implemented audio encoder, generating a translated output from the output of a neural network-implemented audio encoder, and delivering the translated output as input to a neural network-implemented audio decoder for audio playback, wherein the output of the neural network-implemented audio encoder is incompatible as input to the neural network-implemented audio decoder for audio playback of audio encoded by the neural network-implemented audio encoder.

The method may further include generating the translated output using a trained neural network.

The method may further include generating the translated output at a network node disposed between a first node that hosts the neural network-implemented audio encoder and a second node that hosts the neural network-implemented audio decoder.

The method may further include generating the translated output at a node that hosts the neural network-implemented audio decoder.

In the method, the output of the neural network-implemented audio encoder may be a first codeword or a first codeword index, and the translated output is a second codeword or second codeword index, different from the first codeword or the first codeword index, respectively.

The method may further include dequantizing the output of the neural network-implemented audio encoder to obtain one or more embedding vectors, and translating the one or more embedding vectors into one or more translated embedding vectors compatible with the neural network-implemented audio decoder.

The method may further include quantizing the one or more translated embedding vectors into one or more codewords or codeword indexes that are compatible with the neural network-implemented audio decoder.

In the method, the neural network-implemented audio encoder may perform encoding according to a process that is different from, or is a different version of, an encoding process for which the neural network-implemented audio decoder is configured to decode.

In the method, the translated output may be an intermediate translated output, and the method further include: generating a further translated output of the intermediate translated output, and delivering the further translated output as input to the neural network-implemented audio decoder for audio playback.

In the method, the neural network-implemented audio decoder may support an audio processing feature not supported by the neural network-implemented audio encoder.

In another embodiment, a device may be provided and may include an interface configured to enable network communications, a memory, and one or more processors coupled to the interface and the memory, and configured to: receive an output of a neural network-implemented audio encoder, generate a translated output from the output of a neural network-implemented audio encoder, and deliver the translated output as input to a neural network-implemented audio decoder for audio playback, wherein the output of the neural network-implemented audio encoder is incompatible as input to the neural network-implemented audio decoder for audio playback of audio encoded by the neural network-implemented audio encoder.

In the device, the one or more processors may be further configured to generate the translated output using a trained neural network.

In the device, the one or more processors may be further configured to generate the translated output at a network node disposed between a first node that hosts the neural network-implemented audio encoder and a second node that hosts the neural network-implemented audio decoder.

In the device, the one or more processors may be further configured to generate the translated output at a node that hosts the neural network-implemented audio decoder.

In the device, the output of the neural network-implemented audio encoder may be a first codeword or a first codeword index, and the translated output is a second codeword or second codeword index, different from the first codeword or the first codeword index, respectively.

In the device, the one or more processors may be further configured to dequantize the output of the neural network-implemented audio encoder to obtain one or more embedding vectors, and translate the one or more embedding vectors into one or more translated embedding vectors compatible with the neural network-implemented audio decoder.

In the device, the one or more processors may be further configured to quantize the one or more translated embedding vectors into one or more codewords or codeword indexes that are compatible with the neural network-implemented audio decoder.

In yet another embodiment, one or more non-transitory computer readable storage media encoded with instructions are provided and that, when executed by a processor, cause the processor to receive an output of a neural network-implemented audio encoder, generate a translated output from the output of a neural network-implemented audio encoder, and deliver the translated output as input to a neural network-implemented audio decoder for audio playback, wherein the output of the neural network-implemented audio encoder is incompatible as input to the neural network-implemented audio decoder for audio playback of audio encoded by the neural network-implemented audio encoder.

The one or more non-transitory computer readable storage media may include instructions that are configured to generate the translated output using a trained neural network.

In connection with the one or more non-transitory computer readable storage media, the output of the neural network-implemented audio encoder is a first codeword or a first codeword index, and the translated output is a second codeword or second codeword index, different from the first codeword or the first codeword index, respectively.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
receiving an output of a neural network-implemented audio encoder;
generating a translated output from the output of a neural network-implemented audio encoder; and
delivering the translated output as input to a neural network-implemented audio decoder for audio playback,
wherein the output of the neural network-implemented audio encoder is incompatible as input to the neural network-implemented audio decoder for audio playback of audio encoded by the neural network-implemented audio encoder.

2. The method of claim 1, further comprising generating the translated output using a trained neural network.

3. The method of claim 1, further comprising generating the translated output at a network node disposed between a first node that hosts the neural network-implemented audio encoder and a second node that hosts the neural network-implemented audio decoder.

4. The method of claim 1, further comprising generating the translated output at a node that hosts the neural network-implemented audio decoder.

5. The method of claim 1, wherein the output of the neural network-implemented audio encoder is a first codeword or a first codeword index, and the translated output is a second codeword or second codeword index, different from the first codeword or the first codeword index, respectively.

6. The method of claim 1, further comprising dequantizing the output of the neural network-implemented audio encoder to obtain one or more embedding vectors, and translating the one or more embedding vectors into one or more translated embedding vectors compatible with the neural network-implemented audio decoder.

7. The method of claim 6, further comprising quantizing the one or more translated embedding vectors into one or more codewords or codeword indexes that are compatible with the neural network-implemented audio decoder.

8. The method of claim 1, wherein the neural network-implemented audio encoder performs encoding according to a process that is different from, or is a different version of, an encoding process for which the neural network-implemented audio decoder is configured to decode.

9. The method of claim 1, wherein the translated output is an intermediate translated output, and the method further comprising:
generating a further translated output of the intermediate translated output; and
delivering the further translated output as input to the neural network-implemented audio decoder for audio playback.

10. The method of claim 1, wherein the neural network-implemented audio decoder supports an audio processing feature not supported by the neural network-implemented audio encoder.

11. A device comprising:
an interface configured to enable network communications;
a memory; and
one or more processors coupled to the interface and the memory, and configured to:
receive an output of a neural network-implemented audio encoder;
generate a translated output from the output of a neural network-implemented audio encoder; and
deliver the translated output as input to a neural network-implemented audio decoder for audio playback,
wherein the output of the neural network-implemented audio encoder is incompatible as input to the neural network-implemented audio decoder for audio playback of audio encoded by the neural network-implemented audio encoder.

12. The device of claim 11, wherein the one or more processors are further configured to generate the translated output using a trained neural network.

13. The device of claim 11, wherein the one or more processors are further configured to generate the translated output at a network node disposed between a first node that hosts the neural network-implemented audio encoder and a second node that hosts the neural network-implemented audio decoder.

14. The device of claim 11, wherein the one or more processors are further configured to generate the translated output at a node that hosts the neural network-implemented audio decoder.

15. The device of claim 11, wherein the output of the neural network-implemented audio encoder is a first codeword or a first codeword index, and the translated output is a second codeword or second codeword index, different from the first codeword or the first codeword index, respectively.

16. The device of claim 11, wherein the one or more processors are further configured to dequantize the output of the neural network-implemented audio encoder to obtain one or more embedding vectors, and translate the one or more embedding vectors into one or more translated embedding vectors compatible with the neural network-implemented audio decoder.

17. The device of claim 16, wherein the one or more processors are further configured to quantize the one or more translated embedding vectors into one or more codewords or codeword indexes that are compatible with the neural network-implemented audio decoder.

18. One or more non-transitory computer readable storage media encoded with instructions that, when executed by a processor, cause the processor to:
receive an output of a neural network-implemented audio encoder;
generate a translated output from the output of a neural network-implemented audio encoder; and
deliver the translated output as input to a neural network-implemented audio decoder for audio playback,
wherein the output of the neural network-implemented audio encoder is incompatible as input to the neural network-implemented audio decoder for audio playback of audio encoded by the neural network-implemented audio encoder.

19. The one or more non-transitory computer readable storage media of claim 18, wherein the instructions are configured to generate the translated output using a trained neural network.

20. The one or more non-transitory computer readable storage media of claim 18, wherein the output of the neural network-implemented audio encoder is a first codeword or a first codeword index, and the translated output is a second codeword or second codeword index, different from the first codeword or the first codeword index, respectively.
